(19) United States
(12) Patent Application Publication
(10) Pub. No.: US 2025/0193659 A1
(43) Pub. Date: Jun. 12, 2025

(54) SYSTEM AND METHOD FOR TRIGGERING ELEMENTS IN A NETWORK

(71) Applicant: JIO PLATFORMS LIMITED, Ahmedabad, Gujarat (IN)

(72) Inventors: Aayush BHATNAGAR, Navi Mumbai, Maharashtra (IN); Anurag SINHA, Mumbai, Maharashtra (IN); Hardik Navinbhai BAVISHI, Navi Mumbai, Maharashtra (IN); Sandeep BISHT, Kalyan Thane, Maharashstra (IN); Kumar Gaurav SINGH, Panvel, Maharashtra (IN); Nilesh SANAS, Navi Mumbai, Maharashtra (IN); Amit Kumar SINGH, Kalyan East, Maharashtra (IN); Raghvendra BHUSHAN, Kalyan, Thane, Maharashtra (IN); Mangesh Shantaram KALE, Navi Mumbai, Maharashtra (IN); Gaurav JAIN, Ghansoli, Maharashtra (IN)

(73) Assignee: JIO PLATFORMS LIMITED, Ahmedabad, Gujarat (IN)

(21) Appl. No.: 18/993,230

(22) PCT Filed: May 8, 2024
(86) PCT No.: PCT/IN2024/050501

§ 371 Date: Jan. 10, 2025

(30) Foreign Application Priority Data
May 30, 2023 (IN) 202321037379

(51) Int. Cl. H04W 8/24; H04W 4/14; H04W 88/16

(52) U.S. Cl. CPC H04W 8/245; H04W 4/14; H04W 88/16

(57) ABSTRACT

The present disclosure provides a method for triggering elements in a network (301). The method comprising communicating a device trigger (DT) request to a network exposure function (NEF) (304), communicating a mobile management entity (MME) identifier (ID) request to a unified data management (UDM) (308), and obtaining an MME ID response including the MME ID from the UDM (308). The method comprising communicating the DT request and the MME ID to a service capabilities exposure function (SCEF) (306), communicating the DT request and the MME ID to an internet protocol short message (IPSM) gateway/short message service center (SMSC) (312), communicating the DT request to a mobile management entity (MME)/access and mobility management function (AMF) (316) based on the MME ID. The method comprising communicating by the MME/AMF (316), the DT request to a user equipment (UE) (318).

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to a system and a method for triggering elements in a network. Further, the present disclosure mitigates one or more issues of triggering user equipment (UE) devices and/or network elements in the network.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

The third-generation partnership project (3GPP) standards evolve with time and cover aspects of integration and features that a node supports in a telecommunications network. However, a lack of explicit description of the interaction between 4G and fifth generation (5G) nodes, like a service capabilities exposure function (SCEF) and a network exposure function (NEF), may create issues in communication. Further, current systems do not provide information regarding an application function's (AF's) interaction with the NEF and the SCEF through a common application programming interface framework (CAPIF). Further, the AF needs to support N33 interface (reference point between the NEF and the AF) and T8 application programming interface (APIs) in the telecommunications network. In an example, the T8 APIs provide two group message delivery methods, including the Multimedia Broadcast Multicast Service (MBMS), which requires that the MBMS information be distributed to the recipient UEs before the group message is broadcast over the identified geographical area. The N33 APIs are used to enable external Application Functions to communicate with the 5G Network Functions in a secure manner. The N33 interface exposes APIs that allow applications to update parameters that are already configured in 5GC. Applications may consume these APIs and provoke the 5GC to take specific actions. Thus, the lack of explicit description of the interaction between the AF's interaction with the NEF and the SCEF may create issues in communication.

There is, therefore, a need in to provide a system and a method that can mitigate the problems associated with the prior arts.

### OBJECTS OF THE INVENTION

It is an object of the present disclosure to provide a system and a method for triggering elements in a fourth generation (4G) network using a converged network exposure function (CNEF) node via a predefined interface.

It is an object of the present disclosure to provide a system and a method where an NEF may send a subscription request (device trigger request) towards an SCEF using the interface to avoid a diameter interface over the NEF as it is already available on SCEF towards internet protocol short message gateway/short message service center (IPSM/SMSC).

It is an object of the present disclosure to provide a robust communication system and management of nodes.

It is an object of the present disclosure to remotely control one or more network elements.

### SUMMARY

In an exemplary embodiment, the present invention discloses a method for triggering elements in a network. The method comprising communicating, by an application function (AF), a device trigger (DT) request to a network exposure function (NEF). The method comprising communicating, by the NEF, a mobile management entity (MME) identifier (ID) request to a unified data management (UDM). The method comprising obtaining, by the NEF, an MME ID response including the MME ID from the UDM. The method comprising communicating, by the NEF, the DT request, and the MME ID to a service capabilities exposure function (SCEF). The method comprising communicating, by the SCEF, the DT request and the MME ID to an internet protocol short message (IPSM) gateway/short message service center (SMSC). The method comprising communicating, by the IPSM gateway/SMSC, the DT request to a mobile management entity (MME)/access and mobility management function (AMF) based on the MME ID. The method comprising communicating, by the MME/AMF, the DT request to a user equipment (UE). The method comprising receiving, by the IPSM gateway/SMSC, a DT response from the MME/AMF. The method comprising receiving, by the NEF, the DT response from the SCEF over a predefined interface and receiving, by the AF, the DT response from the NEF.

In an embodiment, the method comprising authorizing, by the NEF, the AF based on the DT request.

In an embodiment, the authorization of the AF comprising the steps of communicating, by the NEF, an identifier (ID) translation request, to the UDM and receiving, by the NEF, a response from the UDM responsive to the ID translation request.

In an embodiment, the method comprising receiving, by the SCEF, the DT response from the IPSM gateway/SMSC.

In an embodiment, the method comprising communicating, by the UDM, the MME ID request to a home subscriber server (HSS) and receiving, by UDM, the MME ID response including the MME ID from the HSS.

In an embodiment, the NEF communicates the DT request and the MME ID to the SCEF either via hypertext transfer protocol version 2 (HTTP2) communication protocol or via HTTP2 to hypertext transfer protocol version 1 (HTTP1) communication protocol conversion.

In an embodiment, the method comprising communicating, by the UE, a message delivery report to the MME/AMF and communicating, by the MME/AMF, the message delivery report to the IPSM gateway/SMSC.

In an embodiment, the method comprising communicating, by the IPSM gateway/SMSC, the message delivery report to the SCEF, communicating, by the SCEF, the message delivery report to the NEF and communicating, by the NEF, the message delivery report to the AF.

In an embodiment, the SCEF communicates the DT request and the MME ID to the IPSM gateway/SMSC over a diameter connection.

In an embodiment, the UE is a 4G attached UE.

In an exemplary embodiment, the present invention discloses a system for triggering elements in a network. The system comprising a receiving unit configured to receive a device trigger (DT) request, a database configured to store the DT request, and a processing unit coupled to the receiving unit and the database. The processing unit is configured for communicating, by an application function (AF), a device trigger (DT) request to a network exposure function (NEF). The processing unit is configured for communicating, by the NEF, a mobile management entity (MME) identifier (ID) request to a unified data management (UDM). The processing unit is configured for obtaining, by the NEF, an MME ID response including the MME ID from the UDM. The processing unit is configured for communicating, by the NEF, the DT request, and the MME ID to a service capabilities exposure function (SCEF). The processing unit is configured for communicating, by the SCEF, the DT request and the MME ID to an internet protocol short message (IPSM) gateway/short message service center (SMSC). The processing unit is configured for communicating, by the IPSM gateway/SMSC, the DT request to a mobile management entity (MME)/access and mobility management function (AMF) based on the MME ID. The processing unit is configured for communicating, by the MME/AMF, the DT request to a user equipment (UE). The processing unit is configured for receiving, by the IPSM gateway/SMSC, a DT response from the MME/AMF. The processing unit is configured for receiving, by the NEF, the DT response from the SCEF over a predefined interface and receiving, by the AF, the DT response from the NEF.

In an embodiment, the system is configured for comprising authorizing, by the NEF, the AF based on the DT request.

In an embodiment, the authorization of the AF comprising the steps of communicating, by the NEF, an identifier (ID) translation request, to the UDM and receiving, by the NEF, a response from the UDM responsive to the ID translation request.

In an embodiment, the system is configured for receiving, by the SCEF, the DT response from the IPSM gateway/SMSC.

In an embodiment, the system is configured for communicating, by the UDM, the MME ID request to a home subscriber server (HSS) and receiving, by UDM, the MME ID response including the MME ID from the HSS.

In an embodiment, the NEF communicates the DT request and the MME ID to the SCEF either via hypertext transfer protocol version 2 (HTTP2) communication protocol or via HTTP2 to hypertext transfer protocol version 1 (HTTP1) communication protocol conversion.

In an embodiment, the system is configured for communicating, by the UE, a message delivery report to the MME/AMF and communicating, by the MME/AMF, the message delivery report to the IPSM gateway/SMSC.

In an embodiment, the system is configured for communicating, by the IPSM gateway/SMSC, the message delivery report to the SCEF, communicating, by the SCEF, the message delivery report to the NEF and communicating, by the NEF, the message delivery report to the AF.

In an embodiment, the SCEF communicates the DT request and the MME ID to the IPSM gateway/SMSC over a diameter connection.

In an embodiment, the UE is a 4G attached UE.

In an exemplary embodiment, the present invention discloses user equipment (UE) communicatively coupled with a network, the coupling comprises steps of receiving, by the network, a connection request from the UE, sending, by the network, an acknowledgment of the connection request to the UE and transmitting a plurality of signals in response to the connection request, the network (301) is configured for performing a method for triggering one or more elements. The method comprising communicating, by an application function (AF), a device trigger (DT) request to a network exposure function (NEF). The method comprising communicating, by the NEF, a mobile management entity (MME) identifier (ID) request to a unified data management (UDM). The method comprising obtaining, by the NEF, an MME ID response including the MME ID from the UDM. The method comprising communicating, by the NEF, the DT request, and the MME ID to a service capabilities exposure function (SCEF). The method comprising communicating, by the SCEF, the DT request and the MME ID to an internet protocol short message (IPSM) gateway/short message service center (SMSC). The method comprising communicating, by the IPSM gateway/SMSC, the DT request to a mobile management entity (MME)/access and mobility management function (AMF) based on the MME ID. The method comprising communicating, by the MME/AMF, the DT request to a user equipment (UE). The method comprising receiving, by the IPSM gateway/SMSC, a DT response from the MME/AMF. The method comprising receiving, by the NEF, the DT response from the SCEF over a predefined interface and receiving, by the AF, the DT response from the NEF.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture for implementing a proposed system, in accordance with an embodiment of the present disclosure.

FIG. 2 illustrates an exemplary block diagram of a proposed system, in accordance with an embodiment of the present disclosure.

FIG. 3A illustrates an exemplary system architecture for implementing a proposed system, in accordance with an embodiment of the present disclosure.

FIG. 3B illustrates an exemplary flow diagram of device triggering for a user equipment (UE), in accordance with an embodiment of the present disclosure.

FIG. 4 illustrates an exemplary computer system in which or with which the embodiments of the present disclosure may be implemented.

FIG. 5 illustrates an exemplary flow diagram for a method for triggering elements in a network.

The foregoing shall be more apparent from the following more detailed description of the disclosure.

### LIST OF REFERENCE NUMERALS

100—Network architecture
102-1, 102-2 . . . 102-N—A plurality of users
104-1, 104-2 . . . 104-N—A plurality of computing devices
106—Network
108— System
200— Block diagram
202— Receiving unit
204— Memory
206— Interfacing unit
208— Processing unit
210— Database
300A— System architecture
300B— Flow diagram
302— Application function (AF)
304— Network exposure function (NEF)
306— Service capabilities exposure function (SCEF)
308— Unified data management (UDM)
310— Home subscriber service (HSS)
312— Narrow band (NB)— internet of things (IoT) internet protocol short message gateway (IPSM)/short message service center (SMSC)
314— Short message service function (SMSF)
316— Mobile management entity (MME)/Access and mobility management function (AMF)
318— User equipment (UE)
320-1, 320-2— Internet of things (IoT) devices
400— A computer system
410— External storage device
420— Bus
430— Main memory
440— Read only memory
450— Mass storage device
460— Communication port(s)
470— Processor
500— Flow diagram

### DETAILED DESCRIPTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

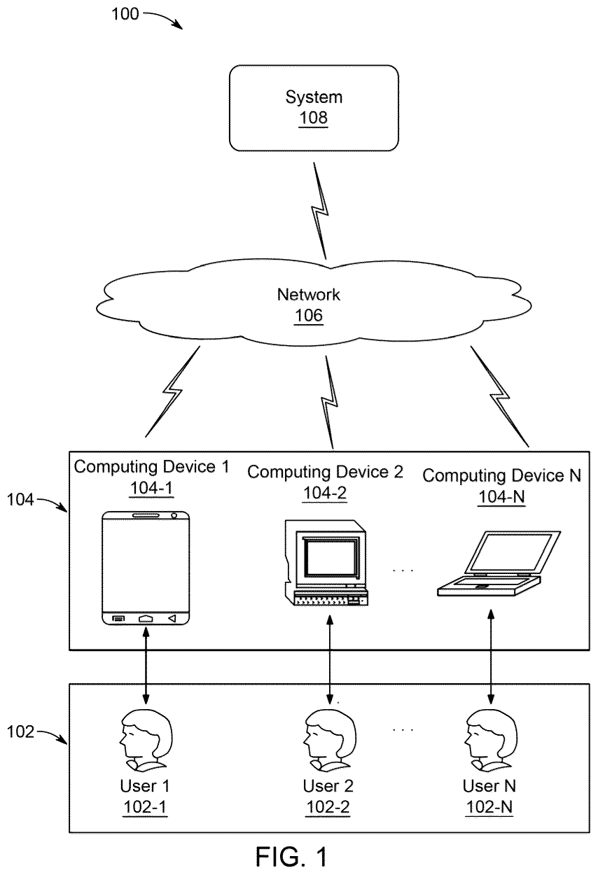

The various embodiments throughout the disclosure will be explained in more detail with reference to FIGS. 1-5.

FIG. 1 illustrates an exemplary network architecture (100) for implementing a proposed system (108), in accordance with an embodiment of the present disclosure.

As illustrated in FIG. 1, one or more computing devices (104-1, 104-2 . . . 104-N) may be connected to a proposed system (108) through a network (106). A person of ordinary skill in the art will understand that the one or more computing devices (104-1, 104-2 . . . 104-N) may be collectively referred as computing devices (104) and individually referred as a computing device (104). One or more users (102-1, 102-2 . . . 102-N) may provide one or more requests to the system (108). A person of ordinary skill in the art will understand that the one or more users (102-1, 102-2 . . . 102-N) may be collectively referred as users (102) and individually referred as a user (102). Further, the computing devices (104) may also be referred as a UE (104) or as UEs (104) throughout the disclosure. In an embodiment the system (108) may be interchangeably referred as a network exposure function and a predefined interface for handling the one or more requests from the users (102).

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the users (102) such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may receive a request from one or more users (102) via the computing device (104). The one or more requests may trigger one or more elements in the network (106) using a converged network exposure function (CNEF) node.

In an embodiment, the CNEF facilitates network exposure and interaction with external systems and the applications. The CNEF is newly developed pre-defined interface between NEF and SCEF. Furthermore, the Converged NEF is a combination of SCEF and NEF. This combination makes converged NEF to expose network capabilities of 4G. The computing device (104) may communicate with a device triggering response system based on the triggered one or more elements. Further, the request may be based on a subscription request from the computing device (104).

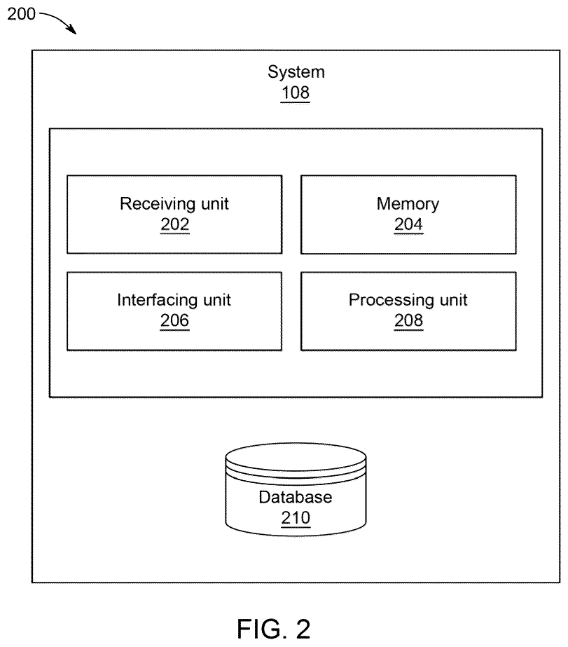

FIG. 2 illustrates an exemplary block diagram (200) of a proposed system (108), in accordance with an embodiment of the present disclosure.

Referring to FIG. 2, in an embodiment, the system (108) may include a receiving unit (202), a memory (204), an interfacing unit (206), a processing unit (208) and a database (210). The receiving unit (202) is configured to receive a device trigger (DT) request, the database (210) is configured to store the DT request. The processing unit (208) is coupled to the receiving unit (202) and the database (210). The processing unit (208) is configured to perform the triggering elements in the network (106).

The processing unit (208) may be implemented as one or more microprocessors, microcomputers, microcontrollers, digital signal processors, central processing units, logic circuitries, and/or any devices that process data based on operational instructions. Among other capabilities, the processing unit (208) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the interfacing unit (206) may comprise a variety of interfaces, for example, interfaces for data input and output devices (I/O), storage devices, and the like. The interfacing unit (206) may facilitate communication through the system (108). The interfacing unit (206) may also provide a communication pathway for one or more components of the system (108).

In an embodiment, the processing unit (208) may be implemented as a combination of hardware and programming (for example, programmable instructions) to implement one or more functionalities of the processing unit (208). In examples described herein, such combinations of hardware and programming may be implemented in several different ways. For example, the programming for the processing unit (208) may be processor-executable instructions stored on a non-transitory machine-readable storage medium and the hardware for the processing unit (208) may comprise a processing resource (for example, one or more processors), to execute such instructions. In the present examples, the machine-readable storage medium may store instructions that, when executed by the processing resource, implement the processing unit (208). In such examples, the system may comprise the machine-readable storage medium storing the instructions and the processing resource to execute the instructions, or the machine-readable storage medium may be separate but accessible to the system and the processing resource. In other examples, the processing unit (208) may be implemented by electronic circuitry.

In an embodiment, the processing unit (208) may receive the DT request via the receiving unit (202). The processing unit (208) may store the DT request in the database (210). The one or more requests may trigger one or more elements in a network (106) using the CNEF node.

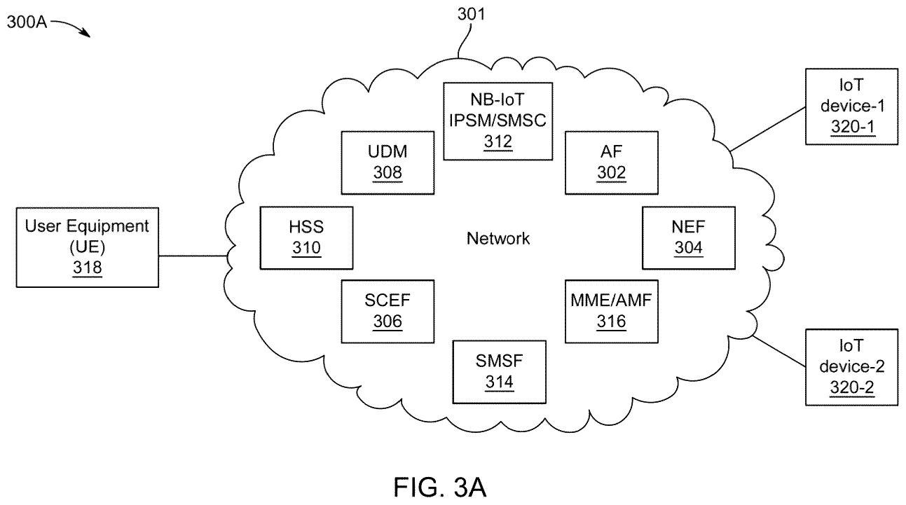

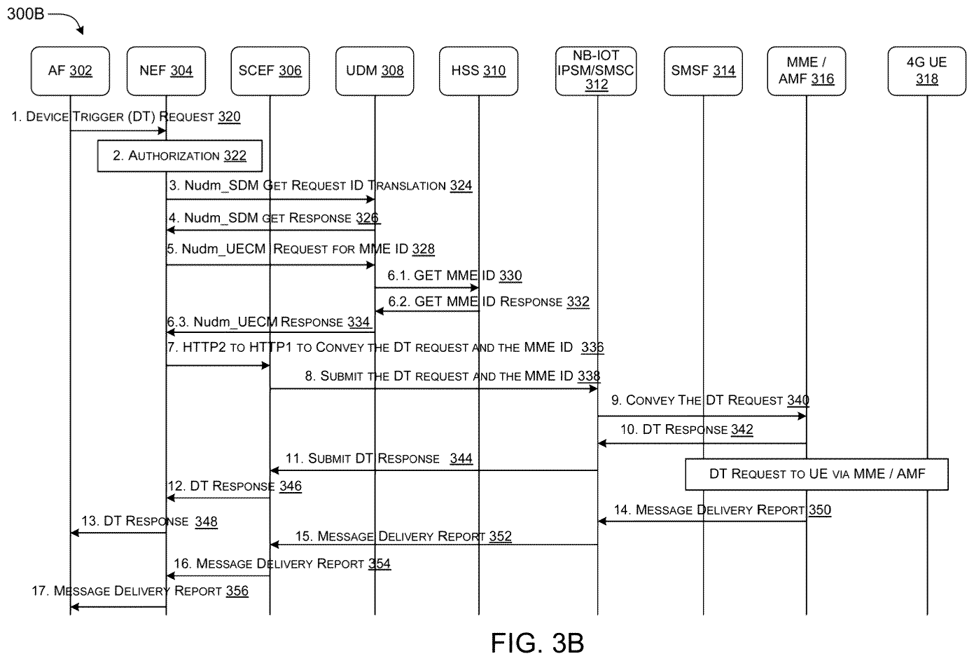

FIG. 3A illustrates an exemplary system architecture for implementing a proposed system, in accordance with an embodiment of the present disclosure.

In an aspect, the system architecture includes at least a user equipment (UE) (318) connected/coupled to the network (301). The network may be a 4G network. In an aspect, the UE (318) may be a 4G attached UE. The network may include a plurality of network elements. For example, the network (301) may include an application function (AF) (302), a network exposure function (NEF) (304), a service capabilities exposure function (SCEF) (306), a unified data management (UDM) (308), a home subscriber service (HSS) (310), a narrow band (NB)-internet of things (IoT) internet protocol short message gateway (IPSM)/short message service center (SMSC) (312), a short message service function (SMSF) (314), a mobile management entity (MME)/access and mobility management function (AMF) (316). The network may be further connected to a plurality of Internet of Things (IoT) devices such as IoT device-1 (320-1) and IoT device-2 (320-2). As a result of the coupling, the UE (318) may be configured to receive a connection request from the network and send an acknowledgment of connection request to the network. The network (301) and the UE (318) may transmit a plurality of signals as a part of process of the connection.

FIG. 3B illustrates an exemplary flow diagram (300) of device triggering for a 4G attached UE (318), in accordance with an embodiment of the present disclosure.

As illustrated in FIG. 3B, the following steps may be implemented.

At step 320: The method comprising communicating, by an application function (AF) (302), a device trigger (DT) request to a network exposure function (NEF) (304).

At step 322: The method comprising authorizing, by the NEF (304), the AF (302) based on the DT request. In an embodiment, the authorization of the AF (302) is performed so that the NEF (304) may check if the AF (302) is eligible to send the messages (e.g., mobile terminated (MT) delivery messages) to the UE (318) or not. After authorization of the AF (302) further steps of device triggering is performed. In an example, the MT delivery messages include short message service (SMS), data push notifications or software updates for the UE (318).

At step 324: The authorization of the AF (302) comprising the steps of communicating, by the NEF (304), a ‘Nudm_SDM Get request’ (e.g., an identifier (ID) translation request) for obtaining various ID translation details from the UDM (308). In an aspect, identifier may include a subscription permanent identifier (SUPI). The SUPI is used to specify the UE for which information is requested. In an aspect, the DT request is an initiation of a request from a network or application to a specific device. The trigger could be initiated for several reasons, such as activating a service, configuring settings, or initiating a specific action. In an aspect, the DT request may include a payload (content) or may not include a content. The payload refers to the data or instructions included in the DT request. The content may include parameters, commands, configurations, or any other information necessary for the UE (318) to understand and execute the requested action.

At step 326: The method comprising receiving, by the NEF (304), a ‘Nudm_SDM get response’ from the UDM (308). In an aspect, the ‘NUDM_SDM get response’ represents the retrieval and delivery of UE (subscriber) related information from the UDM (308).

At step 328: The method comprising communicating, by the NEF (304), a ‘Nudm_UECM request’ for mobile management entity (MME) identifier (ID) to a unified data management (UDM) (308). In an aspect, the ‘Nudm_UECM request’ manages the connectivity of the UE (318) within the network. In an aspect, the ‘Nudm_UECM request’ may be an MME ID request.

At step 330: The method comprising communicating, by the UDM (308), the MME ID request to a home subscriber server (HSS) (310).

At step 332: The method comprising receiving, by UDM (308), the MME ID response including the MME ID from the HSS (310).

At step 334: The method comprising obtaining, by the NEF (304), an ‘Nudm_UECM response’ including the MME ID from the UDM (308). In an aspect, the ‘Nudm_UECM response’ may be an MME ID response.

At step 336: The method comprising communicating, by the NEF (304), the DT request and the MME ID to a service capabilities exposure function (SCEF) (306) via a predefined interface. In an aspect, the MME ID can be conveyed from NEF (304) to SCEF (306) via either hypertext transfer protocol version 2 (HTTP2) communication protocol or via some protocol conversion (from HTTP2 to HTTP1) in case any of the NEF (304) to SCEF (306) fail to support the communication protocol.

At step 338: The method comprising communicating, by the SCEF (306), the DT request and the MME ID to an internet protocol short message (IPSM) gateway/short message service center (SMSC) (312).

At step 340: The method comprising communicating, by the IPSM gateway/SMSC (312), the DT request to a mobile management entity (MME)/access and mobility management function (AMF) (316) based on the MME ID. In an aspect, the method comprising communicating, by the MME/AMF (316), the DT request to the UE (318). In an aspect the DT request may be conveyed through a MT delivery request.

At step 342: The method comprising receiving, by the IPSM gateway/SMSC (312), a DT response from the MME/AMF (316).

At step 344: The method comprising receiving, by the SCEF (306), the DT response from the IPSM gateway/SMSC (312).

At step 346: The method comprising receiving, by the NEF (304), the DT response from the SCEF (306) over a predefined interface.

At step 348: The method comprising receiving (520), by the AF (302), the DT response from the NEF (304).

At step 350: The method comprising communicating, by the MME/AMF (316), a message delivery report (received from the UE (318)) to the IPSM gateway/SMSC (312). The message delivery report helps the AF (302) for further interaction with the UE (318).

At step 352: The method comprising communicating, by the IPSM gateway/SMSC (312), the message delivery report to the SCEF (306).

At step 354: The method comprising communicating, by the SCEF (306), the message delivery report to the NEF (304).

At step 356: The method comprising communicating, by the NEF (304), the message delivery report to the AF (302).

In an embodiment, the NEF (304) may send the subscription (DT request and the MME ID) towards the SCEF (306) using the predefined application programming interface (API). This implementation may avoid a diameter interface over the NEF (304) as the diameter interface is already available on the SCEF (306) towards the internet protocol short message gateway/short message service center (IPSM/SMSC). Further, the NEF (304) may send the MME identity for 4G attached UE.

In an embodiment, the NEF (304) may query the UDM (308) for the MME identity in order to deliver a trigger to the 4G connected UE (104). The UDM (308) may query the HSS (310) internally to fetch the MME identity.

In an embodiment, in case of 4G attached UE (104), the UDM (308) may return the MME ID to the NEF (304) in response. The NEF (304) may forward the MME ID to the SCEF (306) over the predefined interface.

In an embodiment, for an evolved packet core (EPC) 4G case, the SCEF (306) may use an existing diameter connection to forward a device triggering message having the MME identities to the IPSM/SMSC (312).

In an embodiment, for an EPC 4G case, the IPSM/SMSC may deliver the DT request to UE (318) via the MME (316). If a delivery report is enabled, then data buffering may be unavailable at the IPSM gateway/SMSC (312) and a Delivery-Report-Request (DRR) command may be performed for 4G over an existing diameter connection. The DRR request delivery reports for messages sent from one network element to another. For example, when a sender sends a message, particularly in SMS or other messaging systems, they may request a delivery report to confirm whether the message was successfully delivered to the recipient's device. The DRR command is used to initiate this request.

In an embodiment, if data is being buffered at IPSM/SMSC due to UE's non-reachability in a fifth-generation core (5GC) network and if a user is attached in the EPC, then the IPSM/SMSC may receive a trigger from the HSS (310). The trigger may include an MME identity based on which a buffered data may be delivered over the EPC instead of the 5GC and vice versa.

In an exemplary embodiment, the present invention discloses a method for triggering elements in a network. The method comprising communicating, by an application function (AF), a device trigger (DT) request to a network exposure function (NEF). The method comprising communicating, by the NEF, a mobile management entity (MME) identifier (ID) request to a unified data management (UDM). The method comprising obtaining, by the NEF, an MME ID response including the MME ID from the UDM. The method comprising communicating, by the NEF, the DT request, and the MME ID to a service capabilities exposure function (SCEF). The method comprising communicating, by the SCEF, the DT request and the MME ID to an internet protocol short message (IPSM) gateway/short message service center (SMSC). The method comprising communicating, by the IPSM gateway/SMSC, the DT request to a mobile management entity (MME)/access and mobility management function (AMF) based on the MME ID. The method comprising communicating, by the MME/AMF, the DT request to a user equipment (UE). The method comprising receiving, by the IPSM gateway/SMSC, a DT response from the MME/AMF. The method comprising receiving, by the NEF, the DT response from the SCEF over a predefined interface and receiving, by the AF, the DT response from the NEF.

In an embodiment, the method comprising authorizing, by the NEF, the AF based on the DT request.

In an embodiment, the authorization of the AF comprising the steps of communicating, by the NEF, an identifier (ID) translation request, to the UDM and receiving, by the NEF, a response from the UDM responsive to the ID translation request.

In an embodiment, the method comprising receiving, by the SCEF, the DT response from the IPSM gateway/SMSC.

In an embodiment, the method comprising communicating, by the UDM, the MME ID request to a home subscriber server (HSS) and receiving, by UDM, the MME ID response including the MME ID from the HSS.

In an embodiment, the NEF communicates the DT request and the MME ID to the SCEF either via hypertext transfer protocol version 2 (HTTP2) communication protocol or via HTTP2 to hypertext transfer protocol version 1 (HTTP1) communication protocol conversion.

In an embodiment, the method comprising communicating, by the UE, a message delivery report to the MME/AMF and communicating, by the MME/AMF, the message delivery report to the IPSM gateway/SMSC.

In an embodiment, the method comprising communicating, by the IPSM gateway/SMSC, the message delivery report to the SCEF, communicating, by the SCEF, the message delivery report to the NEF and communicating, by the NEF, the message delivery report to the AF.

In an embodiment, the SCEF communicates the DT request and the MME ID to the IPSM gateway/SMSC over a diameter connection.

In an embodiment, the UE is a 4G attached UE.

In an exemplary embodiment, the present invention discloses a system for triggering elements in a network. The system comprising a receiving unit configured to receive a device trigger (DT) request, a database configured to store the DT request, and a processing unit coupled to the receiving unit and the database. The processing unit is configured for communicating, by an application function (AF), a device trigger (DT) request to a network exposure function (NEF). The processing unit is configured for communicating, by the NEF, a mobile management entity (MME) identifier (ID) request to a unified data management (UDM). The processing unit is configured for obtaining, by the NEF, an MME ID response including the MME ID from the UDM. The processing unit is configured for communicating, by the NEF, the DT request, and the MME ID to a service capabilities exposure function (SCEF). The processing unit is configured for communicating, by the SCEF, the DT request and the MME ID to an internet protocol short message (IPSM) gateway/short message service center (SMSC). The processing unit is configured for communicating, by the IPSM gateway/SMSC, the DT request to a mobile management entity (MME)/access and mobility management function (AMF) based on the MME ID. The processing unit is configured for communicating, by the MME/AMF, the DT request to a user equipment (UE). The processing unit is configured for receiving, by the IPSM gateway/SMSC, a DT response from the MME/AMF. The processing unit is configured for receiving, by the NEF, the DT response from the SCEF over a predefined interface and receiving, by the AF, the DT response from the NEF.

In an embodiment, the system is configured for comprising authorizing, by the NEF, the AF based on the DT request.

In an embodiment, the authorization of the AF comprising the steps of communicating, by the NEF, an identifier (ID) translation request, to the UDM and receiving, by the NEF, a response from the UDM responsive to the ID translation request.

In an embodiment, the system is configured for receiving, by the SCEF, the DT response from the IPSM gateway/SMSC.

In an embodiment, the system is configured for communicating, by the UDM, the MME ID request to a home subscriber server (HSS) and receiving, by UDM, the MME ID response including the MME ID from the HSS.

In an embodiment, the NEF communicates the DT request and the MME ID to the SCEF via either via hypertext transfer protocol version 2 (HTTP2) communication protocol or via HTTP2 to hypertext transfer protocol version 1 (HTTP1) communication protocol conversion.

In an embodiment, the system is configured for communicating, by the UE, a message delivery report to the MME/AMF and communicating, by the MME/AMF, the message delivery report to the IPSM gateway/SMSC.

In an embodiment, the system is configured for communicating, by the IPSM gateway/SMSC, the message delivery report to the SCEF, communicating, by the SCEF, the message delivery report to the NEF and communicating, by the NEF, the message delivery report to the AF.

In an embodiment, the SCEF communicates the DT request and the MME ID to the IPSM gateway/SMSC over a diameter connection.

In an embodiment, the UE is a 4G attached UE.

In an exemplary embodiment, the present invention discloses user equipment (UE) communicatively coupled with a network, the coupling comprises steps of receiving, by the network, a connection request from the UE, sending, by the network, an acknowledgment of the connection request to the UE and transmitting a plurality of signals in response to the connection request, the network (301) is configured for performing a method for triggering one or more elements. The method comprising communicating, by an application function (AF), a device trigger (DT) request to a network exposure function (NEF). The method comprising communicating, by the NEF, a mobile management entity (MME) identifier (ID) request to a unified data management (UDM). The method comprising obtaining, by the NEF, an MME ID response including the MME ID from the UDM. The method comprising communicating, by the NEF, the DT request, and the MME ID to a service capabilities exposure function (SCEF). The method comprising communicating, by the SCEF, the DT request and the MME ID to an internet protocol short message (IPSM) gateway/short message service center (SMSC). The method comprising communicating, by the IPSM gateway/SMSC, the DT request to a mobile management entity (MME)/access and mobility management function (AMF) based on the MME ID. The method comprising communicating, by the MME/AMF, the DT request to a user equipment (UE). The method comprising receiving, by the IPSM gateway/SMSC, a DT response from the MME/AMF. The method comprising receiving, by the NEF, the DT response from the SCEF over a predefined interface and receiving, by the AF, the DT response from the NEF.

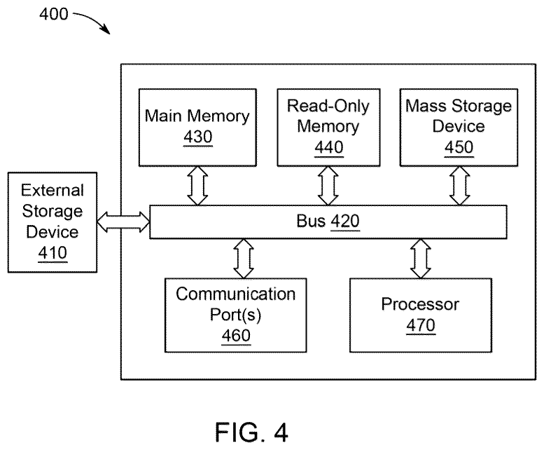

FIG. 4 illustrates an exemplary computer system (400) in which or with which embodiments of the present disclosure may be implemented.

As shown in FIG. 4, the computer system (400) may include an external storage device (410), a bus (420), a main memory (430), a read-only memory (440), a mass storage device (450), a communication port(s) (460), and a processor (470). A person skilled in the art will appreciate that the computer system (400) may include more than one processor and communication ports. The processor (470) may include various modules associated with embodiments of the present disclosure. The communication port(s) (460) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (460) may be chosen depending on a network, such as a Local Area Network (LAN), Wide Area Network (WAN), or any network to which the computer system (400) connects.

In an embodiment, the main memory (430) may be Random Access Memory (RAM), or any other dynamic storage device commonly known in the art. The read-only memory (440) may be any static storage device(s) e.g., but not limited to, a Programmable Read Only Memory (PROM) chip for storing static information e.g., start-up or basic input/output system (BIOS) instructions for the processor (470). The mass storage device (450) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (420) may communicatively couple the processor(s) (470) with the other memory, storage, and communication blocks. The bus (420) may be, e.g., a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (470) to the computer system (400).

In another embodiment, operator and administrative interfaces, e.g., a display, keyboard, and cursor control device may also be coupled to the bus (420) to support direct operator interaction with the computer system (400). Other operator and administrative interfaces can be provided through network connections connected through the communication port(s) (460). Components described above are meant only to exemplify various possibilities. In no way should the aforementioned exemplary computer system (400) limit the scope of the present disclosure.

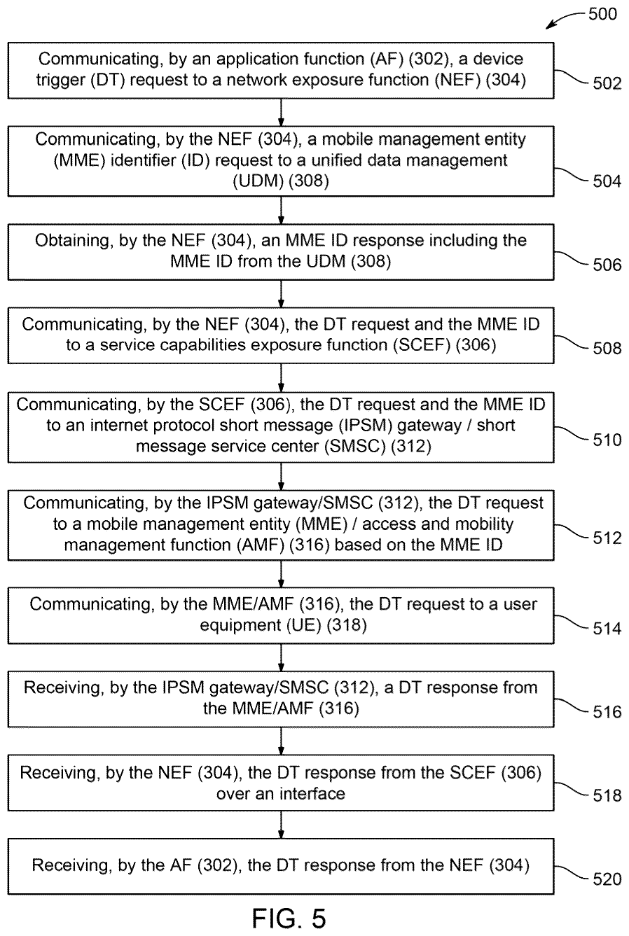

FIG. 5 illustrates an exemplary flow diagram for a method for triggering elements in a network.

At step 502, the method comprising communicating, by an application function (AF) (302), a device trigger (DT) request to a network exposure function (NEF) (304).

At step 504, the method comprising communicating, by the NEF (304), a mobile management entity (MME) identifier (ID) request to a unified data management (UDM) (308).

At step 506, the method comprising obtaining, by the NEF (304), an MME ID response including the MME ID from the UDM (308).

At step 508, the method comprising communicating (508), by the NEF (304), the DT request and the MME ID to a service capabilities exposure function (SCEF) (306) via a predefined interface.

At step 510, the method comprising communicating, by the SCEF (306), the DT request and the MME ID to an internet protocol short message (IPSM) gateway/short message service center (SMSC) (312).

At step 512, the method comprising communicating, by the IPSM gateway/SMSC (312), the DT request to a mobile management entity (MME)/access and mobility management function (AMF) (316) based on the MME ID.

At step 514, the method comprising communicating, by the MME/AMF (316), the DT request to a user equipment (UE) (318).

At step 516, the method comprising receiving, by the IPSM gateway/SMSC (312), a DT response from the MME/AMF (316).

At step 518, the method comprising receiving, by the NEF (304), the DT response from the SCEF (306) over the predefined interface.

At step 520, the method comprising receiving, by the AF (302), the DT response from the NEF (304).

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

In an aspect, the present disclosure provides a system and a method where the NEF will send a subscription towards the SCEF using a predefined API to avoid diameter interface over the NEF as it is already available on SCEF towards the internet protocol short message gateway/short message service center (IPSM/SMSC). In an aspect, the present disclosure provides a robust communication system and method for triggering the elements in network.

In an aspect, the present disclosure can be implemented within a communication network or with various network elements that may involve various algorithms, protocols, or mechanisms for triggering a plurality of elements.

### Advantages of the Invention

The present disclosure provides a system and a method for triggering elements in a fourth generation (4G) network using a converged network exposure function (CNEF) node via a predefined interface.

The present disclosure provides a system and a method where a NEF will send a subscription towards a service capabilities exposure function (SCEF) using a predefined application programming interface (API) to avoid diameter interface over the NEF as it is already available on SCEF toward internet protocol short message gateway/short message service center.

The present disclosure provides a robust communication system and method for triggering the elements in network.

1. A method for triggering elements in a network, the method comprising:
communicating, by an application function (AF), a device trigger (DT) request to a network exposure function (NEF);
communicating, by the NEF, a mobile management entity (MME) identifier (ID) request to a unified data management (UDM);
obtaining, by the NEF, an MME ID response including the MME ID from the UDM;
communicating, by the NEF, the DT request and the MME ID to a service capabilities exposure function (SCEF) via a predefined interface;
communicating, by the SCEF, the DT request and the MME ID to an internet protocol short message (IPSM) gateway/short message service center (SMSC);
communicating, by the IPSM gateway/SMSC, the DT request to a mobile management entity (MME)/access and mobility management function (AMF) based on the MME ID;
communicating, by the MME/AMF, the DT request to a user equipment (UE);
receiving, by the IPSM gateway/SMSC, a DT response from the MME/AMF;
receiving, by the NEF, the DT response from the SCEF over the predefined interface; and
receiving, by the AF, the DT response from the NEF.

2. The method as claimed in claim 1, further comprising authorizing, by the NEF, the AF based on the DT request.

3. The method as claimed in claim 2, wherein the authorization of the AF comprising the steps of:
communicating, by the NEF, an identifier (ID) translation request, to the UDM; and
receiving, by the NEF, a response from the UDM responsive to the ID translation request.

4. The method as claimed in claim 1, further comprising receiving, by the SCEF, the DT response from the IPSM gateway/SMSC.

5. The method as claimed in claim 1, further comprising:
communicating, by the UDM, the MME ID request to a home subscriber server (HSS); and
receiving, by UDM, the MME ID response including the MME ID from the HSS.

6. The method as claimed in claim 1, wherein the NEF communicates the DT request and the MME ID to the SCEF either via hypertext transfer protocol version 2 (HTTP2) communication protocol or via HTTP2 to hypertext transfer protocol version 1 (HTTP1) communication protocol conversion.

7. The method as claimed in claim 1, further comprising:
communicating, by the UE, a message delivery report to the MME/AMF; and
communicating, by the MME/AMF, the message delivery report to the IPSM gateway/SMSC.

8. The method as claimed in claim 7, further comprising:
communicating, by the IPSM gateway/SMSC, the message delivery report to the SCEF;
communicating, by the SCEF, the message delivery report to the NEF; and
communicating, by the NEF, the message delivery report to the AF.

9. The method as claimed in claim 1, wherein the SCEF communicates the DT request and the MME ID to the IPSM gateway/SMSC over a diameter connection.

10. (canceled)

11. A system for triggering elements in a network, the system comprising:
a receiving unit configured to receive a device trigger (DT) request;
a database configured to store the DT request;
a processing unit coupled to the receiving unit and the database, wherein the processing unit is configured for:
communicating, by an application function (AF), the DT request to a network exposure function (NEF);
communicating, by the NEF, a mobile management entity (MME) identifier (ID) request to a unified data management (UDM);
obtaining, by the NEF, an MME ID response including the MME ID from the UDM;
communicating, by the NEF, the DT request and the MME ID to a service capabilities exposure function (SCEF) via a predefined interface;
communicating, by the SCEF, the DT request and the MME ID to an internet protocol short message (IPSM) gateway/short message service center (SMSC);
communicating, by the IPSM gateway/SMSC, the DT request to a mobile management entity (MME)/access and mobility management function (AMF) based on the MME ID;
communicating, by the MME/AMF, the DT request to a user equipment (UE);
receiving, by the IPSM gateway/SMSC, a DT response from the MME/AMF;
receiving, by the NEF, the DT response from the SCEF over the predefined interface; and
receiving, by the AF, the DT response from the NEF.

12. The system as claimed in claim 11, further configured for authorizing, by the NEF, the AF based on the DT request.

13. The system as claimed in claim 12, wherein for the authorization of the AF, the system is configured for:
communicating, by the NEF, an identifier (ID) translation request, to the UDM; and
receiving, by the NEF, a response from the UDM responsive to the ID translation request.

14. The system as claimed in claim 11, further configured for receiving, by the SCEF, the DT response from the IPSM gateway/SMSC.

15. The system as claimed in claim 11, further configured for:
communicating, by the UDM, the MME ID request to a home subscriber server (HSS); and
receiving, by UDM, the MME ID response including the MME ID from the HSS.

16. The system as claimed in claim 11, wherein the NEF (304) communicates the DT request and the MME ID to the SCEF either via hypertext transfer protocol version 2 (HTTP2) communication protocol or via HTTP2 to hypertext transfer protocol version 1 (HTTP1) communication protocol conversion.

17. The system as claimed in claim 11, further configured for:
communicating, by the UE, a message delivery report to the MME/AMF; and
communicating, by the MME/AMF, the message delivery report to the IPSM gateway/SMSC.

18. The system as claimed in claim 17, further configured for:
communicating, by the IPSM gateway/SMSC, the message delivery report to the SCEF;
communicating, by the SCEF, the message delivery report to the NEF; and
communicating, by the NEF, the message delivery report to the AF.

19. The system as claimed in claim 11, wherein the SCEF communicates the DT request and the MME ID to the IPSM gateway/SMSC over a diameter connection.

20. (canceled)

21. A user equipment (UE) communicatively coupled with a network, the coupling comprises steps of:
receiving, by the network, a connection request from the UE;
sending, by the network, an acknowledgment of the connection request to the UE; and
transmitting a plurality of signals in response to the connection request, wherein the network is configured for performing a method for triggering one or more elements as claimed in claim 1.

22. A computer program product comprising a non-transitory computer-readable medium comprising instructions that, when executed by one or more processors, cause the one or more processors to perform a method for triggering elements in a network, the method comprising:
communicating, by an application function (AF), a device trigger (DT) request to a network exposure function (NEF);
communicating, by the NEF, a mobile management entity (MME) identifier (ID) request to a unified data management (UDM);
obtaining, by the NEF, an MME ID response including the MME ID from the UDM;
communicating, by the NEF (304), the DT request and the MME ID to a service capabilities exposure function (SCEF);
communicating, by the SCEF, the DT request and the MME ID to an internet protocol short message (IPSM) gateway/short message service center (SMSC);
communicating, by the IPSM gateway/SMSC, the DT request to a mobile management entity (MME)/access and mobility management function (AMF);
communicating, by the MME/AMF, the DT request to a user equipment (UE);
receiving, by the IPSM gateway/SMSC, a DT response from the MME/AMF;
receiving, by the NEF, the DT response from the SCEF over an interface; and
receiving, by the AF, the DT response from the NEF.
